(19) United States
(12) Patent Application Publication
(10) Pub. No.: US 2006/0196302 A1
(43) Pub. Date: Sep. 7, 2006

(54) Clamping device in particular for a steering column

(75) Inventors: Harald Hochmuth, Hagenbuchach (DE); Sigurd Wilhelm, Herzogenaurach (DE); Bernhard Wiesneth, Erlangen (DE); Alexander Zernickel, Herzogenaurach (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: INA-Schaeffler KG, Herzogenaurach (DE)

(21) Appl. No.: 11/303,391

(22) Filed: Dec. 16, 2005

Related U.S. Application Data
(60) Provisional application No. 60/647,559, filed on Jan. 27, 2005.

(51) Int. Cl. B62D 1/16

(52) U.S. Cl. 74/492

(57) ABSTRACT

Clamping device, especially for a steering column, with a first ramp plate, which can rotate relative to a second ramp plate between a released position and a clamped position by changing a distance between the ramp plates is provided. The first ramp plate (2) and the second ramp plate (3) each have at least two lifting ramps (5, 6) arranged in the circumferential direction for roller bodies and at least one guiding recess, and more preferably two diagonal guiding recesses (9, 10), in the plane of the ramp plates (2, 3) for control elements. The lifting ramps (5, 6) and the guiding recesses (9, 10) of the first and the second ramp plate (2, 3) are arranged so that they operate in opposite directions relative to each other. The roller bodies and the control elements are held in recesses (8) of a holding element (4) arranged between the ramp plates (2, 3).

### FIELD OF THE INVENTION

The invention relates to a clamping device, in particular for a steering column, with a first ramp plate, which can be rotated relative to a second ramp plate between a released position and a clamped position by changing the distance between the ramp plates.

### BACKGROUND

Clamping devices of this type can be used, for example, in motor vehicles and allow the steering-wheel position to be adapted to the individual requirements of the driver. For setting the position of the steering wheel, the clamping device is brought into the released position, in which both the height and also the inclination of the steering wheel is adjustable, by activating a lever. After setting the steering wheel, the clamping device is brought back into the clamped position.

From U.S. Pat. No. 5,394,767, a clamping device is known, in which the distance between a first plate and a second plate is changed, such that balls roll up a ramp, which is provided on the second plate, when the first plate rotates relative to the second plate. Here, due to the high necessary clamping forces, it is a disadvantage that the plates must be made out of metal, which leads to high costs due to the spherical recesses necessary for guiding the balls.

From DE 103 04 640 A1, a clamping device for steering columns is known, in which two opposing ramp plates and an intermediate guidance element, which is used as a ball cage, are provided. However, only one ramp plate features deformations for roller bodies or balls, so that these do not experience restricted guidance. Therefore, there can be the case that the balls do not return to their original position when the clamping device is released.

In DE 101 53 889 A1, a ball ramp actuator for a locking mechanism is described. This clamping device comprises two ramp plates with ball lifting ramps, which are arranged so that they operate in different directions relative to each other and which are not arranged in the circumferential direction. Optionally, an elastically deformable ball holder or cage is provided in order to exert a biasing force on the balls. However, this clamping device leads to an undesired rebound when the activation lever is released.

### SUMMARY OF THE INVENTION

Therefore, the invention is based on the objective of providing a clamping device, which features restricted guidance of the roller body and which prevents undesired rebound of the roller body.

To meet this objective, for a clamping device of the type named above, the first ramp plate and the second ramp plate each feature at least two lifting ramps arranged in the circumferential direction for roller bodies and at least one guiding recess, preferably two guiding recesses, arranged diagonally in the plane of the ramp plates for control elements; the lifting ramps and the guiding recesses of the first and the second ramp plates are each arranged so that they operate in opposite directions relative to each other; the roller body and the control elements are held in recesses of a holding element arranged between the ramp plates.

For the clamping device according to the invention, roller bodies run between the first and the second ramp plates. The ramp plates each feature lifting ramps arranged in the peripheral direction for the roller bodies, so that when the two ramp plates rotate relative to each other, the distance between the ramp plates changes. Between the ramp plates, there is a holding element, which features recesses for the roller bodies and the control elements similar to a bearing cage or ball cage. Next to these recesses, both ramp plates feature diagonal guiding recesses for control elements, which are arranged so that they operate in opposite directions relative to each other for the first and the second ramp plate. The control elements experience restricted guidance due to the guiding recesses, that is, when the two ramp plates rotate, the control elements are also displaced. Through the displacement of the control elements, a sudden and undesired rebound of the roller bodies into the original position is prevented.

For the clamping device according to the invention, spherical or cylindrical roller bodies are particularly well suited. Analogously, the control elements of the clamping device according to the invention can have a spherical or cylindrical shape.

According to an advantageous refinement of the invention, the cylindrical control element can feature a circular groove adapted to the recess of the holding element in its center region. The center region of the control element features a reduced diameter, so that the control element can be inserted into the recess of the holding element and can be guided by the holding element. Here, the groove in the center region of the control element is adapted to the thickness of the holding element, so that the movement of the control element is limited in the axial direction.

An especially precise guidance of the roller body of the clamping device according to the invention can be achieved when the lifting ramps feature continuously changing contours. Particular suitable are lifting ramps with dome-shaped contours, which are adapted to the size of the roller bodies, especially the size of the balls.

In the clamping device according to the invention, a precise restricted guidance can be achieved if the holding element features recesses adapted to the contours of the roller bodies and the control elements. Accordingly, the holding element can feature round recesses for spherical roller bodies and the holding element can feature groove-like recesses for spherical control elements.

An especially reliable function of the clamping device can be achieved if the control elements guided into the guiding recesses of the ramp plates can move outwards or inwards when the ramp plate rotates in radial guiding recesses of the holding element. For this purpose, the guiding recesses of the ramp plates, in which the control elements are guided, can extend at an angle of, for example, approximately 45° to the radial direction.

If the control elements are formed as cylinders with a center groove, the holding element can feature grooves open to the outside as guiding recesses in order to simplify the assembly of the control elements.

For the clamping device according to the invention, the ramp plates can feature connecting means, in order to connect the ramp plates, the holding element, the roller bodies, and the control elements into one assembly. Advantageously, the connecting means can be formed as a plug, latch, or clip connection.

The clamping device according to the invention can preferably comprise at least two roller bodies and at least one control element. The ramp plates and/or the holding element can be formed of metal or a plastic material.

### BRIEF DESCRIPTION OF THE DRAWINGS

Additional advantages and details of the invention are explained using the preferred embodiments with reference to the figures. The figures are schematic drawings and show:

FIG. 1 is an exploded view of a clamping device according to a first embodiment of the invention;

FIG. 2a is a view of the clamping device in released position;

FIG. 2b is a view of the clamping device in clamped position;

FIG. 3 is an exploded view of a clamping device according to a second embodiment of the invention;

FIG. 4 is another view of the clamping device shown in FIG. 3;

FIG. 5a is a view of the clamping device in released position; and

FIG. 5b is a view of the clamping device in clamped position.

### DETAILED DESCRIPTION OF THE PREFERRED EMBODIMENTS

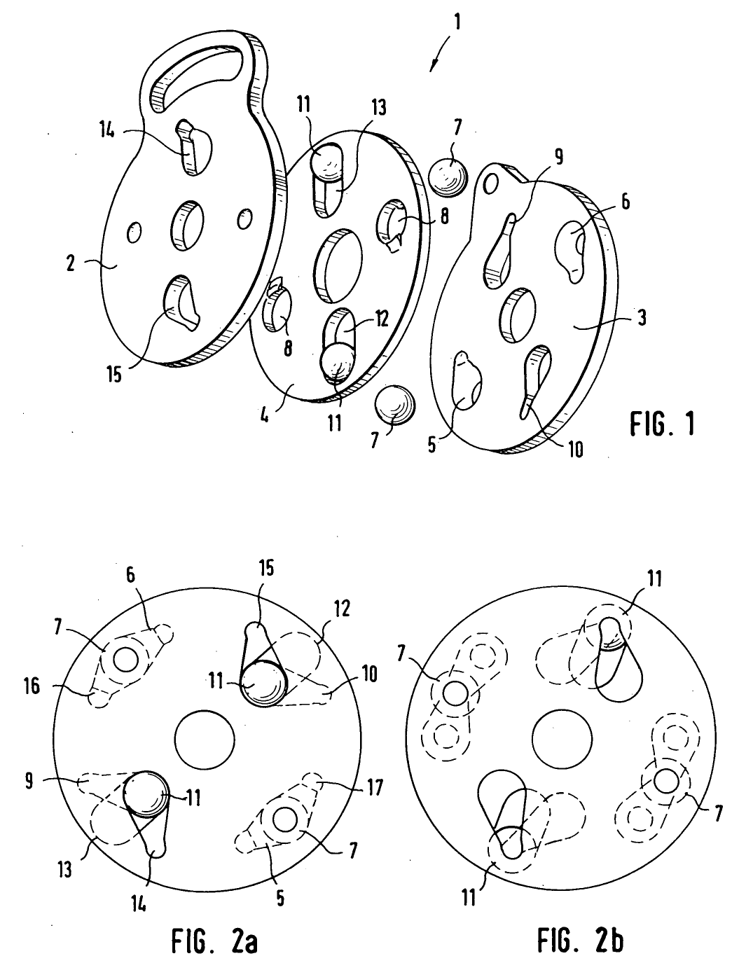

FIG. 1 shows an exploded view of a clamping device 1 formed from a ramp plate 2, another opposing ramp plate 3, and a holding element 4 arranged between the ramp plates 2, 3. The holding element 4 features a plate-like basic shape.

The ramp plates 2, 3 and the holding element 4 have a central bore hole, through which a holding bolt, not shown in FIG. 1, can be inserted. In the installed state, a ramp plate, for example, ramp plate 3, has a fixed position; the other ramp plate 2 can rotate relative to the first ramp plate.

The ramp plates 2, 3 each feature on their inner sides two lifting ramps 5, 6 arranged in the peripheral direction. One lifting ramp of the ramp plate 2 and one lifting ramp of the ramp plate 3 form a ramp pair, between which roller bodies, formed as balls 7, are guided. The lifting ramps 5, 6 extending in the circumferential direction form ramp-like ball tracks, in which the balls 7 are guided when the ramp plate 2 rotates. The lifting ramps 5, 6 are adapted to the shape of the balls 7 and have the shape of a dome.

The holding element 4 features circular recesses 8 for the balls 7. On the inner side of the ramp plate 2 there are also lifting ramps for the balls 7, which are arranged opposite the lifting ramps 5, 6.

In addition, the lifting ramp 3 features guiding recesses 9, 10, which form openings in the ramp plate 3. Other than the lifting ramps 5, 6 which are inclined in the axial direction, the similarly looking guiding recesses 9, 10 are formed as passage openings, so that the axial position of a control element guided into the guiding recesses 9, 10 does not change. Control elements formed as balls 11 are guided in the guiding recesses 9, 10. The balls 11, on their side, run in recesses of the holding element 4, which are formed as guiding grooves 12, 13. The guiding grooves 12, 13 extend in the radial direction of the holding element 4, so that the balls 11 can be displaced in the radial direction when the ramp plate 2 rotates relative to the ramp plate 3.

Similar to the ramp plate 3, the ramp plate 2 also features guiding recesses 14, 15, which are formed as passage openings and are arranged opposite the guiding recesses 9, 10 of the ramp plate 3.

The function of the clamping device 1 is explained with reference to FIGS. 2a and 2b. FIG. 2a shows the essential components of the clamping device in the released position, in which the ramp plates 2, 3 feature a small axial spacing.

As can be seen in FIG. 2a, the balls 7 are located in the lowest position of the lifting ramps 5, 6 of the ramp plate 3 and the lifting ramps 16, 17 of the ramp plate 2. In FIG. 2a, it can also be seen that the guiding recesses 9, 10 intersect with the corresponding guiding recesses 14, 15 of the opposite ramp plate 2. The balls 11 acting as control elements are located at the end of the guiding grooves 12, 13 on the inside in the radial direction. When the rotating ramp plate 2 is activated, the balls 7 roll upwards due to friction on the lifting ramps 6, 16 and 5, 17, that is, the balls 7 roll outwards from the dome in the ramp plates 2, 3. At the same time, the balls 11 acting as control elements run outwards in the guiding grooves 12, 13 of the holding element 4, because the corresponding pair of the guiding recesses 9, 14 and 10, 15 are arranged in the shape of a V.

FIG. 2b shows the clamping device in the clamped position. By rolling the balls 7 outwards from the dome, the axial distance between the ramp plates 2, 3 increases until the clamping device 1 is located in the completely clamped position. In this position, the balls 11 wander outwards in the radial direction in the guiding grooves 12, 13. The balls 7 are also located at their extreme position between the lifting ramps.

If the ramp plates 2, 3 are tilted relative to each other during the activation, the frictional relationships can be changed, such that the balls 7 rebound. In order to prevent rebound, restricted guidance of the holding element 4 by the guiding recesses 9, 14 is provided.

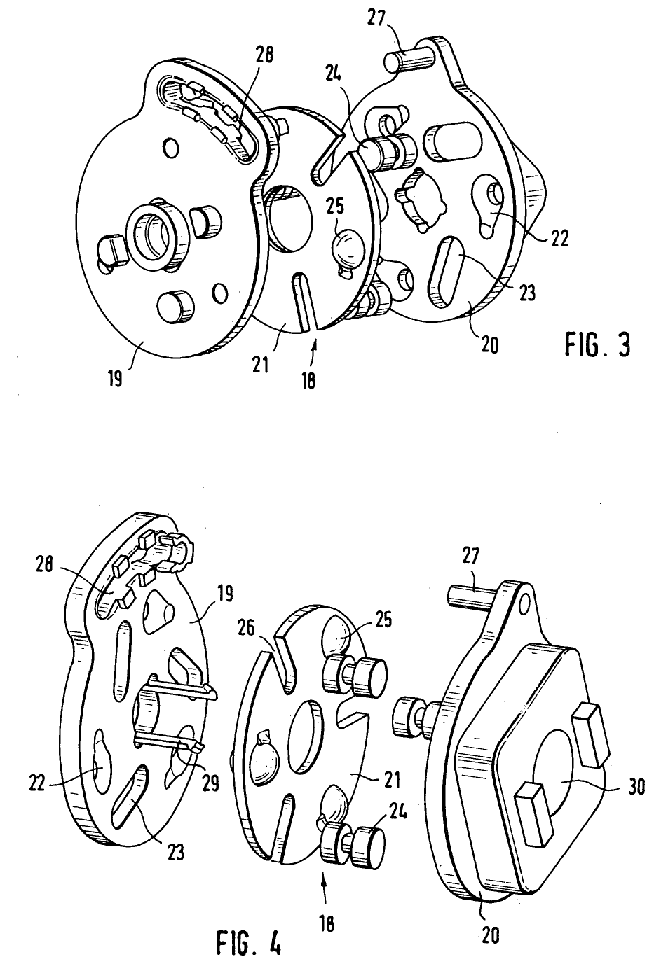

FIG. 3 shows a perspective view of a second embodiment of the invention.

In agreement with the first embodiment, the clamping device 18 comprises ramp plates 19, 20, between which a holding element 21 is arranged. The ramp plates 19, 20 each feature lifting ramps 22 extending in the circumferential direction and guiding recesses 23 running diagonally in the plane of the plate. The shape and position of the lifting ramps 22 corresponds to the lifting ramps of the first embodiment. The guiding recesses 23 are formed as guiding grooves, in which control elements formed as control pins 24 are guided. In this illustrated embodiment, three control pins 24 are used, which alternate with three balls 25, which are guided in the lifting ramps 22.

The control pin 24 has a cylindrical shape, the center section features a reduced diameter and corresponds approximately to a thickness of the holding element 21. The holding element 21 has three grooves 26, which are open to the outside and distributed around the periphery and in each of which a control pin 24 can be inserted. The function when the moving ramp plate rotates essentially corresponds to that of the first embodiment. The ramp plate 20 is fixed in position; in contrast, the ramp plate 19 can rotate. A pin 27, which projects in the axial direction and which can move in a groove 28 of the ramp plate 19 extending the circumferential direction, is formed on the ramp plate 20. The lateral edges of the groove 28 are used as stops for the movement of the ramp plate 19.

In the region of the center of the ramp plate 19 there are two holding sections 29, which project in the axial direction and which feature a thicker section projecting outwards in the radial direction in the region of their end section. The holding sections 29 can be inserted and locked in an opening 30 of the ramp plate 20.

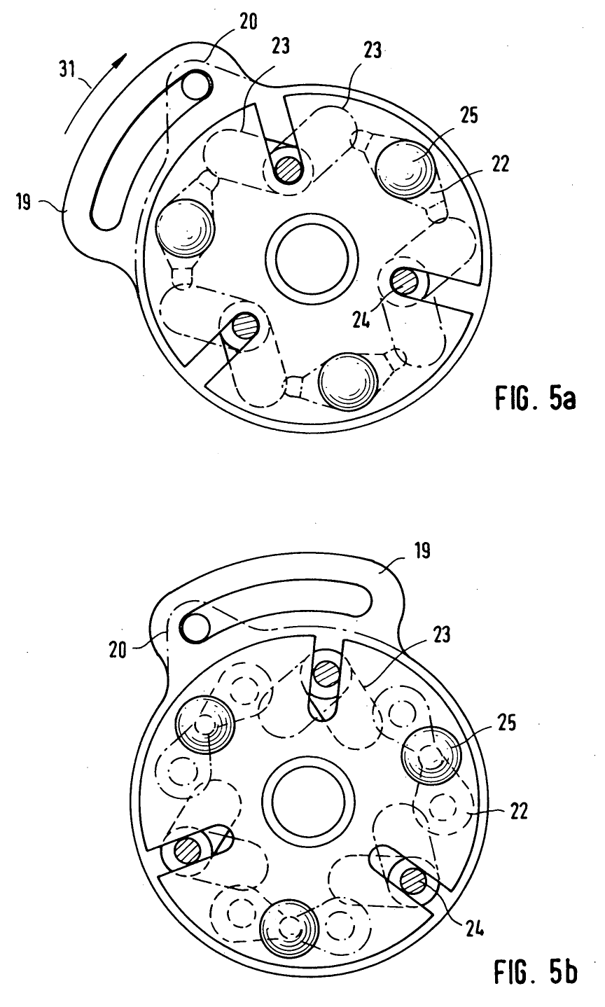

FIG. 5a shows the clamping device 18 in the starting position, in which the ramp plates are released. In this position, the axial length of the clamping device 18 is at a minimum, because the balls 25 are located completely in the domes of the lifting ramps 22. The control pins 24 are located at their innermost position in the radial direction. The center section contacts the inner end of the groove 26 of the holding element 21; the outer end sections of the control pin 24 are located on the end of the guiding recesses 23 close to the center in the ramp plates 19, 20. If the ramp plate 19 is rotated out of the position shown in FIG. 5a in the direction of the arrow 31, the balls 25 roll along the lifting ramps 22 into the position shown in FIG. 5b. Because the lifting ramps 22 are arranged so that they operate in opposite directions, the axial distance between the ramp plates 19, 20 increases, so that the adjustment mechanism for the steering wheel is clamped in this position. At the same time as the movement of the balls 25, the control pins 24 move out of their position close to the center outwards along the grooves 26. Thus, the control pins 24 execute a radial movement along the grooves 26 outwards or inwards when the ramp plate 19 rotates. The movement of the control pins 24 experiences forced guidance, because the outer ends of the control pins 24 are guided in the corresponding guiding recesses 23 of the ramp plates 19, 20. If the rotational movement of the ramp plate 19 is suddenly stopped or the adjusting lever attached thereto is released, this does not lead to rebound of the balls 25 into the original position shown in FIG. 5a or into another, unforeseeable position, because the control pins 24 are held in the grooves 26 and prevent movement in the reverse direction.

### REFERENCE SYMBOLS

1 Clamping device
2 Ramp plate
3 Ramp plate
4 Holding element
5 Lifting ramp
6 Lifting ramp
7 Balls
8 Recesses
9 Guiding recesses
10 Guiding recesses
11 Balls
12 Guiding grooves
13 Guiding grooves
14 Guiding recesses
15 Guiding recesses
16 Lifting ramp
17 Lifting ramp
18 Clamping device
19 Ramp plate
20 Ramp plate
21 Holding element
22 Lifting ramp
23 Guiding recesses
24 Control pins
25 Balls
26 Grooves
27 Pin
28 Groove
29 Holding sections
30 Opening
31 Arrow

1. Clamping device for a steering column, comprising a first ramp plate, which can rotate relative to a second ramp plate between a released position and a clamped position by changing a distance between the ramp plates, the first ramp plate (2, 19) and the second ramp plate (3, 20) each includes at least two lifting ramps (5, 6, 22) arranged in a circumferential direction and roller bodies located on the lifting ramps, and at least one guiding recess (9, 10, 23) arranged diagonally in a plane of the ramp plates (2, 3, 19) and at least one control element arranged in the at least one guiding recess; the lifting ramps (5, 6, 22) and the guiding recesses (9, 10, 23) of the first and the second ramp plate (2, 3, 19, 20) are arranged so that they operate in opposite directions relative to each other; the roller bodies and the at least one control element are held in recesses (8, 23) of a holding element (4, 21) arranged between the ramp plates (2, 3, 19, 20).

2. Clamping device according to claim 1, wherein the roller bodies have a spherical or cylindrical shape.

3. Clamping device according to claim 1, wherein the at least one control element has a spherical or cylindrical shape.

4. Clamping device according to claim 3, wherein the control element is cylindricall and is formed as a control pin (24), and includes a circular groove adapted to a recess of the holding element (21) in a center region thereof.

5. Clamping device according to claim 1, wherein the lifting ramps (5, 6, 22) have continuously varying contours.

6. Clamping device according to claim 1, wherein the lifting ramps (5, 6, 22) have a dome shape.

7. Clamping device according to claim 1, wherein the holding element (4, 21) includes recesses (8) adapted to receive the roller bodies and the at least one control element.

8. Clamping device according to claim 1, wherein the at least one control element comprises control elements and the at least one guiding recess comprises guiding recesses, and the control elements are guided in the guiding recesses (14, 15, 23) of the ramp plates (2, 3, 19, 20) to move outwards or inwards when a ramp plate (2, 19) rotates along radial guiding grooves (12, 13, 26) in the holding element (4, 19).

9. Clamping device according to claim 8, wherein the guiding grooves (26) of the holding element (19) are formed as grooves which open outwardly.

10. Clamping device according to claim 1, wherein the ramp plates (19, 20) include at least one connector which connects the ramp plates (19, 20), the holding element (21), the roller bodies, and the at least one control element into one assembly.

11. Clamping device according to claim 10, wherein the at least one connector comprises a plug, latch, or clip connection.

12. Clamping device according to claim 1, wherein the ramp plates (2, 3, 19, 20) are formed of metal or plastic material.

13. Clamping device according to claim 1, wherein the holding element (4, 19) is formed of metal or plastic material.
